(19) United States
(12) Patent Application Publication
(10) Pub. No.: US 2026/0049952 A1
(43) Pub. Date: Feb. 19, 2026

(54) WELDING SYSTEM FOR X-RAY MONITORING OF ELECTRON BEAM WELDS

(71) Applicant: AQUASIUM TECHNOLOGY LIMITED, Cambridge (GB)

(72) Inventor: Alex O'FARRELL, Cambridge (GB)

(21) Appl. No.: 19/102,480

(22) PCT Filed: Nov. 10, 2023
(86) PCT No.: PCT/GB2023/052947

§ 371 Date: Feb. 10, 2025

(30) Foreign Application Priority Data
Nov. 16, 2022 (GB) 2217107.8

(51) Int. Cl. G01N 23/04; B23K 15/00; B23K 15/06; G01N 23/083

(52) U.S. Cl. CPC G01N 23/04; B23K 15/0013; B23K 15/002; B23K 15/06; G01N 23/083; G01N 2223/204; G01N 2223/629

(57) ABSTRACT

There is provided a welding system (16) comprising an evacuatable welding chamber (26), an electron beam gun (20) connected to the welding chamber (26), a control system (44) to modify the direction of an electron beam (22) generated by the electron beam gun (20) and a detector (40) for acquiring X-ray images, wherein first and second X-ray sources (14, 14′) are positioned proximal a weld site (24) within the welding chamber (26). The control system (44) is configured to synchronise acquisition of X-ray images of the weld site (24) by the detector (40) with periodic generation of X-rays by the X-ray sources (14, 14′) in response to an incident electron beam.

### FIELD OF THE INVENTION

This invention relates to a welding system for monitoring of electron beam welds using X-rays.

### Background to the Invention

During electron beam welding, defects in a weld can arise, for example, due to incorrect weld penetration depth and weld porosity. X-rays have been used in other types of welding, see for example CN213302040, to detect defects in aluminium pipes as they are welded, with the defective area marked using a telescopic rod. However often issues arise with targeting the X-rays at the weld site with components required to ensure the beam of X-rays is suitable for use in detection of defects.

### SUMMARY OF THE INVENTION

In accordance with the invention, there is provided a welding system comprising an evacuatable welding chamber, an electron beam gun connected to the welding chamber, a control system to modify the direction of an electron beam generated by the electron beam gun and a detector for acquiring X-ray images, wherein first and second X-ray sources are positioned proximal a weld site within the welding chamber, the first X-ray source emitting X-rays in a first direction through the weld site and the second X-ray source emitting X-rays in a second direction through the weld site, the first and second directions being substantially orthogonal to each other. This ensures the X-ray beam generated by the source is directed through the weld site without the need for collimation of the beam.

The second X-ray source is preferably positioned orthogonally to the first X-ray source.

Preferably the control system is configured to synchronise acquisition of X-ray images of the weld site by the detector with periodic generation of X-rays by the first and second X-ray sources.

The first and second X-ray sources are preferably responsive to an incident electron beam to generate X-rays and may be formed from metals with a high atomic number such as Tungsten or Tantalum.

The first and second X-ray sources are preferably positioned 1 to 5 mm from the weld site and may comprise at least one angled face so as to direct X-rays through the weld site. Typically the first and second X-ray sources will be in the form of an elongate block with at least one inclined upper face.

Preferably the detector comprises at least one input, such as a pinhole fiber optic, located within the welding chamber and typically 10 to 200 mm from the weld site and at least one detector element, such as a photodiode or camera, located outside the welding chamber or within an X-ray shielded box within the chamber.

The detector may comprise one input associated with the first X-ray source and another input associated with the second X-ray source.

An apertured shim may be positioned between the or each input and the weld site so as to reduce welding debris impinging on the input and to provide filtering of low energy X-rays.

The welding system is particularly of use for weld sites comprising materials capable of penetration by low energy X-rays, such as Copper and Aluminium.

Preferably the weld site has a thickness in the range 1 to 3 mm so that X-rays can penetrate the region of the weld.

The invention will now be described, by way of example, with reference to the accompanying drawings in which:

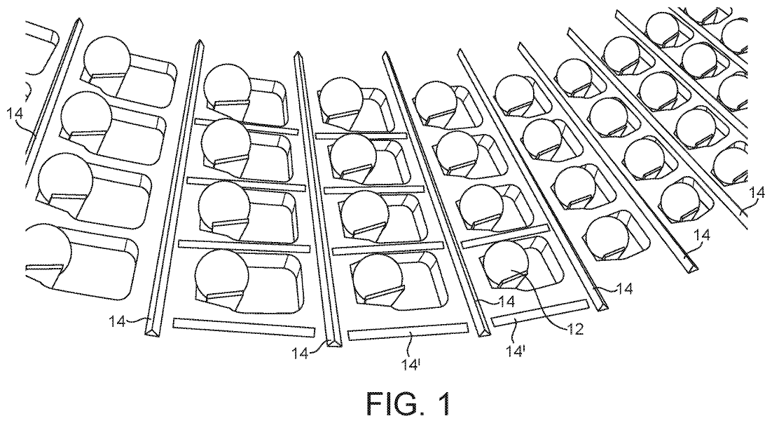

FIG. 1 is a plan view of a workpiece prepared for welding;

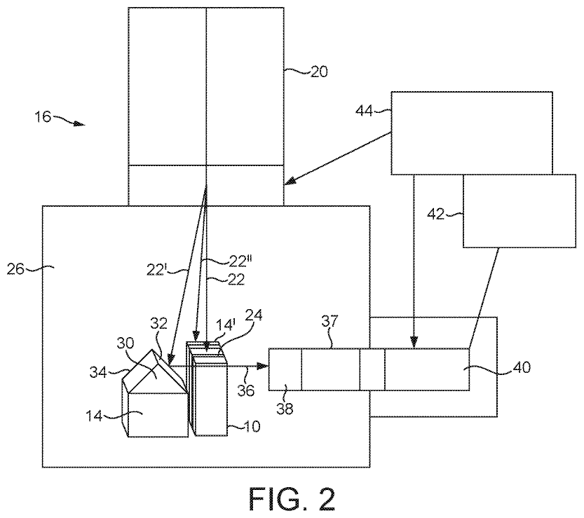

FIG. 2 is a schematic diagram of a welding system used to acquire X-ray images of the workpiece viewed from one side; and

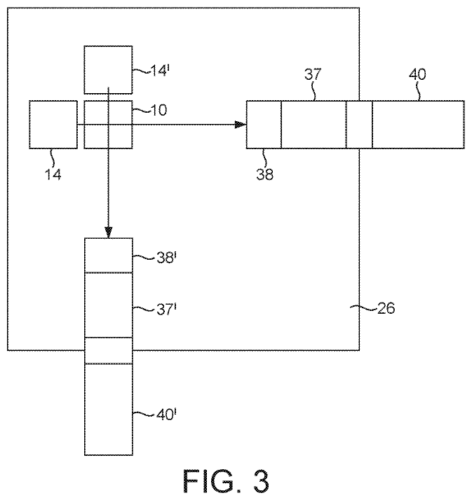

FIG. 3 is a schematic diagram of the welding system.

### DESCRIPTION

FIG. 1 shows a static workpiece 10 including a plurality of copper or aluminium hairpins 12, typically around 1 to 3 mm in thickness, arranged as columns of four and which require spot welding by an electron beam. A first X-ray source in the form of an elongate Tungsten block 14 is secured between each pair of adjacent columns of hairpins 12 using small bolts (not shown) so as to extend along the channel between adjacent columns of hairpins and to be proximal to each hair pin within the column. A second X-ray source is provided by additional Tungsten blocks 14′ located orthogonally to blocks 14 and located between each adjacent row of hair pins such that two orthogonally positioned Tungsten blocks 14, 14′ are proximal to each hair pin. For clarity, only a selected number of blocks 14′ are shown. The plurality of Tungsten blocks 14, 14′ disposed around workpiece 10 allow for generation of X-rays proximal each individual hairpin and so allow for monitoring of weld quality when each hairpin is welded.

A schematic diagram of a welding system 16 with workpiece 10 is shown in FIG. 2 where electron beam gun 20 generates an electron beam 22 with typically a beam diameter ranging from 80 μm to 200 μm. Tungsten block 14′ and part of one of Tungsten blocks 14 are shown located within vacuum chamber 26 proximal weld site 24. Each block 14, 14′ is substantially rectangular with a triangular profile at an upper region 30 so as to present two inclined upper faces 32, 34. Typical dimensions for block 14 are 30 mm in length, 10 mm in height and 5 mm in width. Block 14′ is shorter, typically having a length around 5 to 10 mm.

In response to incident high energy beams 22′, 22″, Tungsten blocks 14, 14′ generate an X-ray beam of similar diameter to the electron beam diameter and so typically the X-ray beam is around 100 μm in diameter. The triangular profile of Tungsten blocks 14, 14′ ensures that inclined upper face 32 proximal weld site 24 emits X-rays at a different angle to the angle of incidence of impinging electron beam 22′, 22″ and so ensures X-ray beam 36, 36′ passes through weld site 24. Depending on the configuration of the item to be welded, the Tungsten X-ray source can be formed in a variety of different shapes.

Tungsten blocks 14, 14′ are placed as close as possible to each hairpin weld site 24, typically located between 1 to 5 mm from the weld site. This ensures that X-ray beams 36, 36′ pass through weld site 24 without collimation of X-ray beams 36, 36′ being required.

Detectors in the form of pinhole fiber optic inputs 37, 37′ located within vacuum chamber 26 close to weld site 24 and positioned orthogonally to each other are used to detect X-rays 36, 36′ transmitted through weld site 24, see FIG. 3. Using a fiber optic or other small pinhole-like input allows inputs 37, 37′ to be located very close to weld site 24 and for multiple switchable inputs to be used if necessary to ensure speed and ease of image acquisition at multiple successive weld sites, such as for a column of individual hairpins.

Inputs 37, 37′ are each connected to an image detector 40, 40′ such as a single photodiode, an array of sensing elements, or an X-ray camera, located outside vacuum chamber 26. The pinhole diameter of inputs 37, 37′ is desirably equal to or less than the beam diameter to ensure a good signal to noise ratio. Optionally, an apertured shim 38, 38′ can be positioned in front of respective inputs 37, 37′ to provide protection from welding debris and to ensure only X-rays that have been transmitted through weld site 24 reach inputs 37, 37′.

X-ray camera 40 comprises a high-speed scintillator and image acquisition electronics. X-ray images detected by camera 40 generate image data which is processed within processor 42. Processed data from processor 42 is passed to deflection control system 44 which alters the direction and focus of electron beam 22, moving beam 22 from weld site 24 to blocks 14, 14′ and controls time of acquisition of images by camera 40.

This arrangement of blocks 14, 14′ as two separated X-ray sources generating X-rays in substantially orthogonal directions to impinge on weld site 24 allows a 3-D image to be generated in real time as the welding takes place and is particularly suitable for workpieces with multiple weld sites at staggered positions relative to each other.

During welding, which typically takes place at voltages of around 40 to 170 kV, electron beam 22 is controlled by system 44 to move between weld site 24 as beam 22, Tungsten block 14 as beam 22′, and Tungsten block 14′ as beam 22″. Movement of the electron beam typically occurs in a raster pattern and takes approximately 250 μs for each traverse from blocks 14, 14′ back to weld site 24. The acquisition of X-ray images by camera 40 is periodic and synchronised to when the electron beam impinges on Tungsten blocks 14, 14′ to generate X-rays. Thus images are acquired at the same time as X-rays are generated from Tungsten blocks 14, 14′.

The resolution of the X-ray image is limited by the response time of the scintillator within camera 40 with a high-speed scintillator typically having a response time of less than 100 μs and so enabling resolutions of greater than 50 ×50 pixels. FPGA closed loop image processing can be used to control the duration of the weld process, monitoring the acquired images to determine when the weld has been completed, and allowing monitoring of beam penetration at the weld site so that welding beam power can be increased to achieve the required melting.

After welding has taken place, the electron beam can, if desired, conduct a high-resolution scan, typically a raster scan, with X-ray images acquired at different depths through weld site 24, producing X-ray slices through the weld which can be used to create a 3-D X-ray image of each weld.

1. A welding system comprising an evacuatable welding chamber, an electron beam gun connected to the welding chamber, a control system to modify the direction of an electron beam generated by the electron beam gun and a detector for acquiring X-ray images, wherein first and second X-ray sources are positioned proximal a weld site within the welding chamber, the first X-ray source emitting X-rays in a first direction through the weld site and the second X-ray source emitting X-rays in a second direction through the weld site, the first and second directions being substantially orthogonal to each other.

2. A welding system according to claim 1, wherein the second X-ray source is positioned orthogonally to the first X-ray source.

3. A welding system according to claim 1, wherein the control system is configured to synchronise acquisition of X-ray images of the weld site by the detector with periodic generation of X-rays by the first and second X-ray sources.

4. A welding system according to claim 1, wherein the first and second X-ray sources are responsive to an incident electron beam to generate X-rays.

5. A welding system according to claim 1, wherein the first and second X-ray sources are formed from Tungsten.

6. A welding system according to claim 1, wherein the first and second X-ray sources are positioned 1 to 5 mm from the weld site.

7. A welding system according to claim 1, wherein the first and second X-ray sources comprise at least one inclined face so as to direct X-rays through the weld site.

8. A welding system according to claim 1, wherein the detector comprises at least one input located within the welding chamber and at least one detector element located outside the welding chamber.

9. A welding system according to claim 8, wherein the detector comprises one input associated with the first X-ray source and another input associated with the second X-ray source.

10. A welding system according to claim 8, wherein an apertured shim is positioned between the input and the weld site.

11. A welding system according to claim 1, wherein the weld site comprises materials capable of penetration by low energy X-rays.

12. A welding system according to claim 1, wherein the weld site has a thickness in the range 1 to 3 mm.
